(19) United States
(12) Patent Application Publication
(10) Pub. No.: US 2018/0093114 A1
(43) Pub. Date: Apr. 5, 2018

(54) PARTICLE RETAINER DEVICE AND METHOD

(71) Applicant: Kevin Woner, Tucson, AZ (US)

(72) Inventor: Kevin Woner, Tucson, AZ (US)

(21) Appl. No.: 15/686,062

(22) Filed: Aug. 24, 2017

Related U.S. Application Data
(60) Provisional application No. 62/404,212, filed on Oct. 5, 2016.

(51) Int. Cl. A62B 23/02

(52) U.S. Cl. CPC A62B 23/02; A62B 18/025

(57) ABSTRACT

A particle retainer having a support frame including at least one air flow port configured to permit contaminated ambient air to reach the filtration element of the particulate matter filtration mask. The particle retainer also has a mask mount fixed to the support frame configured to removably attach the particle retainer to the mask. The particle retainer further includes an air flow port cover affixed to the support frame, in which the air flow port cover features manually operable open state and closed state configurations for permitting and restricting air flow and particulate matter transfer.

### CROSS-REFERENCE TO RELATED APPLICATION(S)

The present application is related to and claims priority to U.S. Provisional Patent Application No. 62/404,212 filed Oct. 5, 2016, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of respirators of existing art and more specifically relates to particulate matter filter devices.

### RELATED ART

Half-face respirators are sometimes worn by those working in hazardous environments, including but not limited to, areas affected by lead-based paint and asbestos. Particulate matter filters may often be attached to the respirators and re-used many times. The filters may be removed and then stored in a plastic bag, toolbox, or other container. The respirator can be cleaned with soap and water. Often, the filters can remain attached to the respirator and then stored. In those cases, the filters themselves are not cleaned and contain hazardous particles that can be easily dislodged. These loose particles may then contaminate a surface or storage area, creating a means of exposure to unprotected individuals. A suitable solution is desired.

U.S. Pat. No. 7,101,412 to Otto Gossweiler relates to a self-sealing protection filter port. The described self-sealing protection filter port includes a self-sealing protection filter port for gas masks prevents contamination of the inner-environment of the mask during exchange of filters and therefore increases safety. A biased valve closes the air inlet to the port when the protection filter is not installed. As a new filter is inserted, the valve is forced open, allowing filtered air to flow through the air inlet to the user. The protection filter engages the filter port using a retaining element. The self-sealing protection filter in a protection mask having an internal close-biased valve is installed in the standard protection filter port of the mask.

### SUMMARY OF THE INVENTION

In view of the foregoing disadvantages inherent in the known respirator art, the present disclosure provides a novel particle retainer device and method. The general purpose of the present disclosure, which will be described subsequently in greater detail, is to provide a open and closable cover for containing hazardous particles that may become dislodged from a respirator filter.

A particle retainer is disclosed herein. The particle retainer may include a support frame having at least one air flow port configured to permit contaminated ambient air to reach a filtration element, a mask mount fixed to the support frame configured to attach the support frame to a particulate matter filtration mask, and an air flow port cover affixed to the support frame. The air flow port cover may be manually operable between an open state and a closed state.

A respiration system is also disclosed herein. The respiration system may include a particulate matter filtration mask, at least one filtration element affixed to the particulate matter filtration mask, and a particle retainer. The particle retainer again may include a support frame, a mask mount, and an air flow port cover.

According to another embodiment, a method of use for the respiration system is also disclosed herein. The method of use may include providing a particulate matter filtration mask, providing a particle retainer for a particulate matter filtration mask, attaching the particle retainer to the air filtration element of the particulate matter filtration mask, opening the particle retainer, and closing the particle retainer.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a particle retainer device and method, constructed and operative according to the teachings of the present disclosure.

FIG. 1 is a perspective view of the particle retainer in the open position during an ‘in-use’ condition, according to an embodiment of the disclosure.

FIG. 2 is a perspective view of the particle retainer in the closed position of FIG. 1 mounted to a particulate matter filtration mask, according to an embodiment of the present disclosure.

FIG. 3 is a top view of the particle retainer of FIG. 1 alongside a filtration element, according to an embodiment of the present disclosure.

FIG. 4 is a bottom perspective view of the particle retainer of FIG. 1, according to an embodiment of the present disclosure.

FIG. 5 is a flow diagram illustrating a method of use for the respiration system, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to respirators and more particularly to a particle retainer device as used to provide a open and closable cover for containing hazardous particles that may become dislodged from a respirator filter. The open and closable cover can be removable or attached as in integral component of a respirator cartridge.

Generally, the present invention provides particulate matter filters with a particle containment system that will prevent hazardous materials from escaping the filter. This eliminates the worry of asbestos, lead-based paint, and other materials from cross-contaminating storage or surface areas when the filter cartridges are not in use. It may utilize a hand-rotatable cover that can contain the filtered particulate matter inside the filter. According to one preferred embodiment, it may be configured to install onto existing PM100 particulate matter type filters, commonly used in conjunction with half-face respirators. This may allow filters and masks to be reused without worry of cross-contamination. The present disclosure advantageously requires minimal training to use the device efficiently.

During the manufacture and remediation of hazardous materials, including asbestos and lead-based paint, particles are often released into the air. Workers in these processes are required by OSHA to wear a respirator equipped with a particulate matter filter to protect the workers from the inhalation of hazardous materials. Many times, containment structures and controlled entry enclosed areas are constructed to prevent the release of hazardous particles into the air outside of the containment or enclosed area. A use of the disclosed particle retainer device is to contain the filtered hazardous particulate matter inside the filter, preventing secondary contamination, for example, in storage containers and on surface areas outside of a containment or enclosed area. A hand rotatable cover installed on the dirty side of the filter may lock the filtered particulate matter inside the particle lock device/particle retainer enclosure.

Currently, following the use of filters attached to half-face respirators used in hazardous materials environments, the filters, which are typically re-used many times, are removed from the half-face respirator then stored inside a plastic bag, toolbox or other suitable container. Sometimes the filters remain attached to the half-face respirator and are stored in a plastic bag or other container. The half-face respirator with filters removed can be cleaned with soap and water and reused over and over. The filters themselves are not cleaned and have no specific storage requirements. The dirty side of the filter collects hazardous particles that can be easily dislodged from the filter media leading to contamination on surfaces outside of a containment area or hazardous materials work area. Particles do fall out of the dirty side of the filter media. These hazardous particles should be contained to prevent hazardous material exposure to unprotected workers and family members.

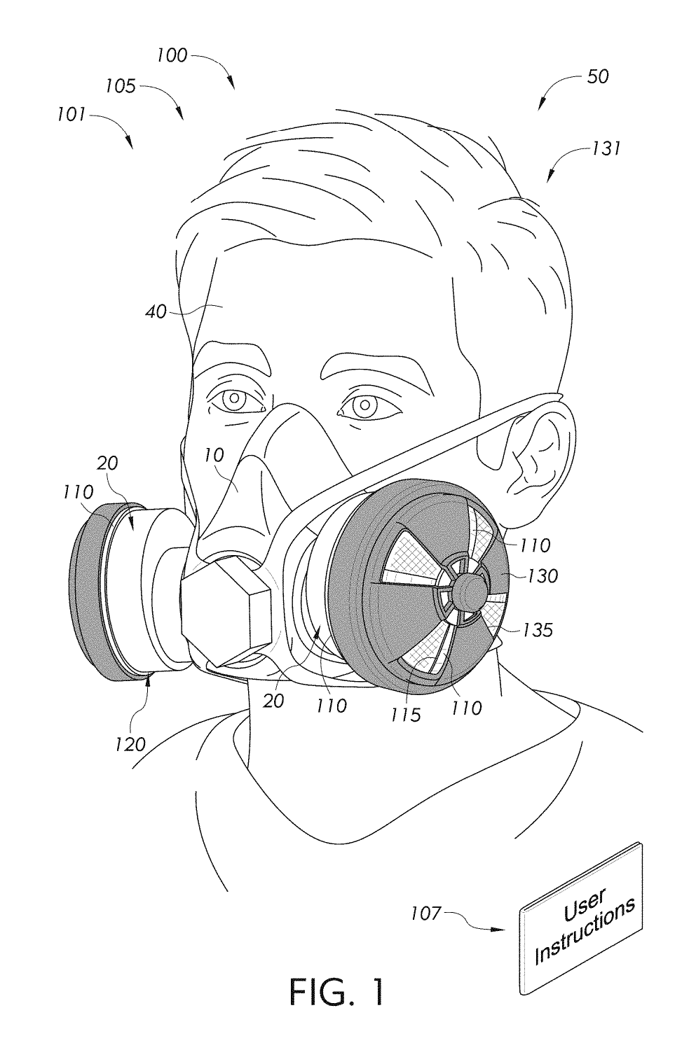

Referring now more specifically to the drawings by numerals of reference, there is shown in FIGS. 1-4, various views of a particle retainer 100.

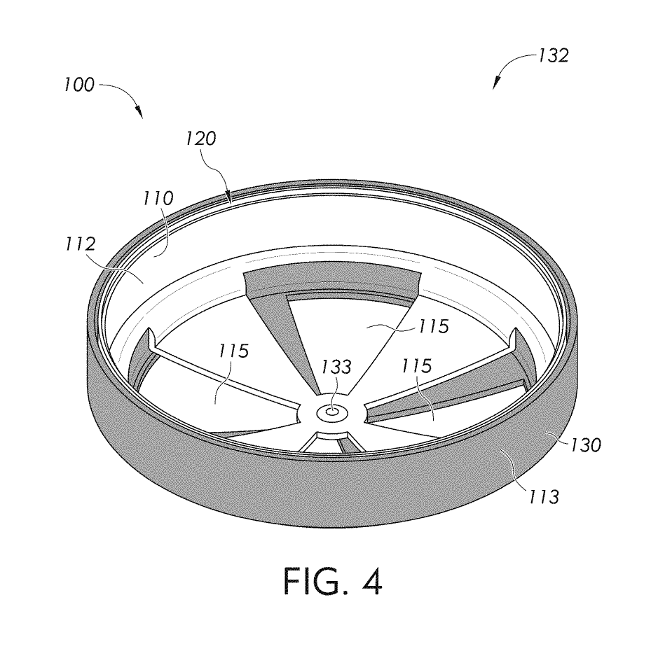

FIG. 1 shows a particle retainer in the open position 100 during an ‘in-use’ condition 50, according to an embodiment of the present disclosure. Here, the particle retainer 100 may be beneficial for use by a user 40 to provide a open and closable cover for containing hazardous particles that may become dislodged from a respirator filter. As illustrated, the particle retainer 100 may include a support frame 110 with a mask mount 120 (FIG. 4) and an air flow port cover 130 affixed to the support frame 110.

The present illustration additionally shows a respiration system 101 including a particulate matter filtration mask 10, at least one air filtration element 20 affixed to the particulate matter filtration mask 10, and the particle retainer 100 including the support frame 110, the mask mount 120, and the air flow port cover 130.

The support frame 110 may itself include at least one air flow port 115 cut from/integrated with the support frame 110, or otherwise configured to permit the contaminated ambient air to reach the at least one air filtration element 20 while coupled to the particulate matter filtration mask 10 and in an open state 131.

According to one embodiment, the respiration system 101 may be arranged as a kit 105. The open and closable cover can be removable or attached as in integral component of a respirator cartridge. In particular, the respiration system 101 may further include a set of instructions 107. The instructions 107 may detail functional relationships in relation to the structure of the respiration system 101 such that the particle retainer 100 can be used, maintained, or the like, in a preferred manner.

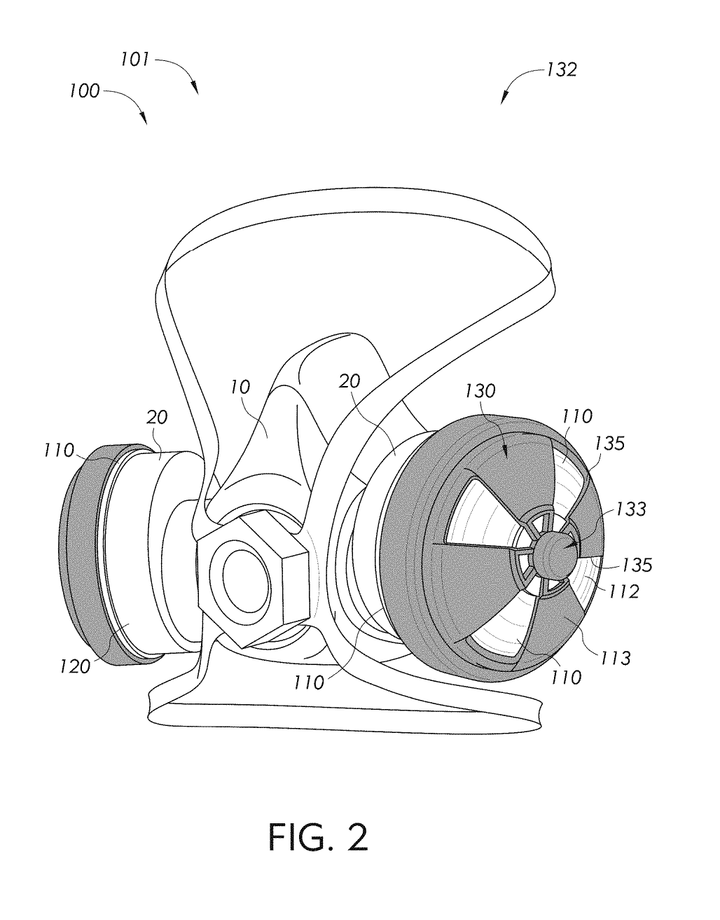

FIG. 2 is a perspective view of the particle retainer FIG. 1, mounted to a particulate matter filtration mask, according to an embodiment of the present disclosure. This illustration shows the air flow port cover 130 in a closed state 132. In particular, here, four flow ports 135 of the air flow port cover 130.are rotated closed or configured to prohibit contaminated ambient air from reaching the air filtration element 20 and to prevent particles from escaping the air filtration element.

As above, the respiration system 101 may include the particulate matter filtration mask 10, the at least one air filtration element 20 affixed to the particulate matter filtration mask 10 and configured to filter particulate matter from contaminated ambient air entering the particulate matter filtration mask 10, and the particle retainer 100 including the support frame 110, the mask mount 120, and the air flow port cover 130.

The air flow port cover 130 may be rotatably or otherwise movably affixed to the support frame 110 (e.g., by a support post 133) and have the open state 131 (FIG. 1) and the closed state 132 (shown). In particular, when in the open state 131, the air flow port cover 130 may align with the air flow port(s) 115 (e.g., via the cover air flow port(s) 135) or otherwise permit the contaminated ambient air to pass through the air flow port(s) 115 of the support frame 110, and when in the closed state 132, as here, the air flow port cover 130 may prohibit particulate matter from passing back through the at least one air flow port 115, for example by closing or otherwise blocking the at least one air flow port 115 (e.g., moving the cover air flow port(s) 135 to a position of interference with the air flow port(s) 115).

According to one embodiment, the particle retainer 100 may also be colored or configured with materials of different/contrasting colors, such that it is readily visible whether the air flow port cover 130 is the open state 131, the closed state 132, or an intermediate state. For example, the support frame 110 may a first color 112, and the air flow port cover 130 may be a second color 113, with the first color 112 contrasting with the second color 113. Alternate embodiments are contemplated (e.g., patterns, indicia, etc.) that similarly make it easier to determine when the particle retainer 100 is currently residing in the open state 131 or the closed state 132.

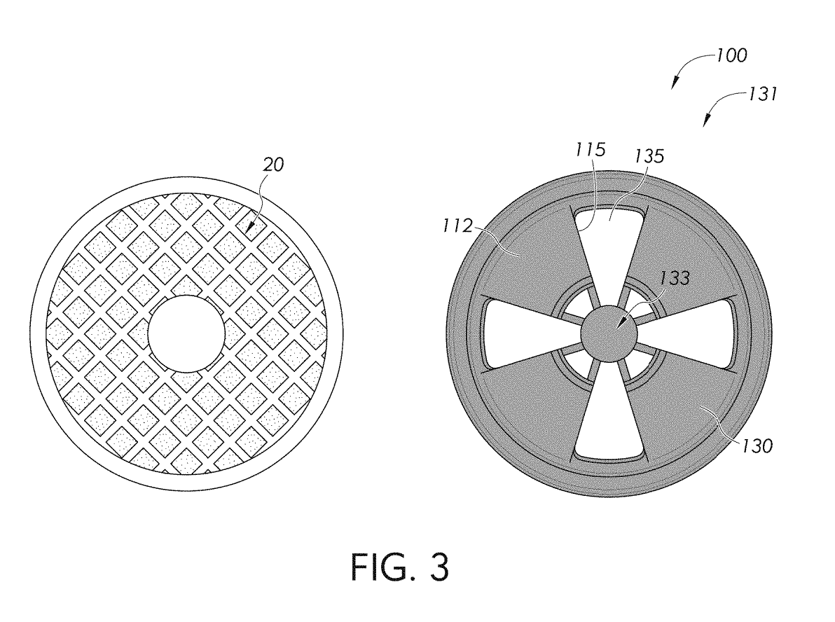

FIG. 3 is a top view of the particle retainer 100 of FIG. 1 alongside a filtration element, according to an embodiment of the present disclosure. This illustration details the particle retainer 100 placed next to one air filtration element 20, or disassembled. This illustration shows the four air flow ports 115 of the support frame 110 and the cover air flow port 135 of air flow port cover 130 in alignment or configured to permit contaminated ambient air to reach the at least one air filtration element 20 (i.e., the open state 131).

FIG. 4 is a bottom or inside perspective view of the particle retainer 100 of FIG. 1, according to an embodiment of the present disclosure. This illustration shows the open state 131 where the four air flow ports 115 and the four cover air flow ports 135 are in alignment or configured to permit contaminated ambient air to reach the at least one air filtration element 20 (FIG. 3).

As shown the mask mount 120 may be integrated with or otherwise affixed to the support frame 110. Similarly, the air flow port cover 130 may be movably affixed the support frame 110 with the support post 133, for example. Other couplings are contemplated, including slots, hinges, rings, flex joints, etc. Further, aspects of the disclosure may include embodiments where the exterior portion of the particle retainer 100 (here the air flow port cover 130) remains fixed and the interior portion of the particle retainer 100 (here the support frame 110) is rotatable or otherwise movable between the open state 131 and the closed state 132.

As above, the support frame 110 may be the first color 112, and the air flow port cover 130 may be the second color 113 in contrast. According to one embodiment the support frame 110 may be made of materials exhibiting the first color 112, and the air flow port cover 130 may be made of materials exhibiting the second color 113.

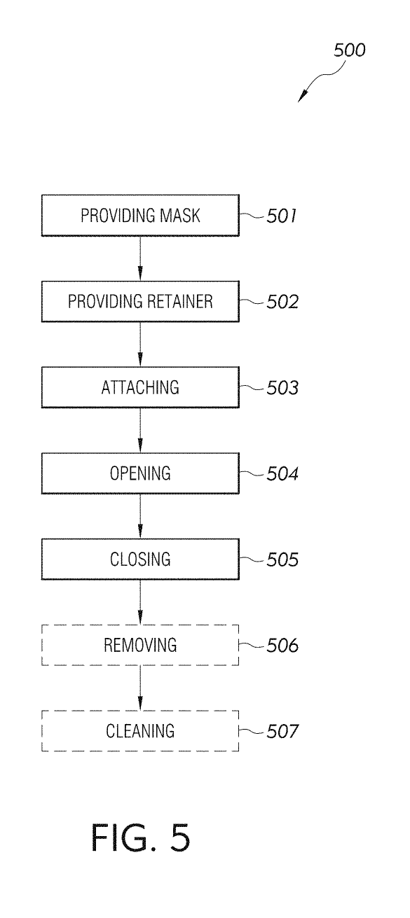

FIG. 5 is a flow diagram illustrating a method of use 500 for a respiration system 101, according to an embodiment of the present disclosure. In particular, the method for method of use 500 may include one or more components or features of the respiration system 101 as described above. As illustrated, the method of use 500 may include the steps of: step one 501, providing the particulate matter filtration mask 10, the particulate matter filtration mask 10 having at least one air filtration element 20 affixed to the particulate matter filtration mask 10 and configured to filter particulate matter from contaminated ambient air entering the particulate matter filtration mask 10; step two 502, providing the particle retainer 100 for the particulate matter filtration mask 10, the particle retainer 100 including the support frame 110, the mask mount 120, and the air flow port cover 130, the support frame 110 including at least one air flow port 115 configured to permit the contaminated ambient air to reach the at least one filtration element, the mask mount 120 fixed to the support frame 110 and configured to removably attach or be integral component of a respirator cartridge to at least one of the particulate matter filtration mask 10 and the at least one filtration element, the air flow port cover 130 affixed to the support frame 110 and having an open state 131 and a closed state 132, the open state 131 permitting the contaminated ambient air to pass through the at least one air flow port 115, and the closed state 132 prohibiting particulate matter from passing back through the at least one air flow port 115; step three 503, attaching the particle retainer 100 to the air filtration element 20; step four 504, opening the particle retainer 100; and step five 505, closing the particle retainer 100. According to one embodiment, the method 500 may further include the steps of: step six 506 removing the particle retainer from the air filtration element; and step seven 507 cleaning the particle retainer.

It should be noted that step six 506 and step seven 507 are optional steps and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for a particle retainer 100, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A particle retainer for a particulate matter filtration mask, the particulate matter filtration mask having at least one air filtration element, the particle retainer comprising:
a support frame including at least one air flow port configured to permit contaminated ambient air to reach the at least one air filtration element of the particulate matter filtration mask;
a mask mount fixed to the support frame and configured to removably attach to the particulate matter filtration element cover;
an air flow port cover affixed to the support frame and having an open state and a closed state, the open state permitting the contaminated ambient air to pass through the at least one air flow port, and the closed state prohibiting particulate matter from passing back through the at least one air flow port.

2. The particle retainer of claim 1, wherein the mask mount is further configured to attach to the air filtration element of the particulate matter filtration mask.

3. The particle retainer of claim 2, wherein the mask mount is configured to form an airtight seal with the air filtration element of the particulate matter filtration mask.

4. The particle retainer of claim 1, wherein the particle retainer is made of plastic.

5. The particle retainer of claim 1, wherein the support frame is a first color, and the air flow port cover is a second color, the first color contrasting with the second color.

6. The particle retainer of claim 1, wherein the mask mount is configured to snap into place on the particulate matter filtration mask.

7. The particle retainer of claim 1, wherein the mask mount and support frame are integrated together as a single unit.

8. The particle retainer of claim 1, wherein the air flow port cover includes at least one cover air flow port, the cover air flow port configured to align with one of the at least one air flow ports in the open state.

9. The particle retainer of claim 1, wherein the air flow port cover is manually operable between the open state to the closed state.

10. The particle retainer of claim 1, wherein the air flow port cover is configured to retain the open state or closed state upon manual selection.

11. The particle retainer of claim 1, further comprising a support post; and
wherein the air flow port cover is affixed to the support frame via the support post.

12. The particle retainer of claim 11, wherein the support post is an item from a list including screws, bolts, pins, rivets, and plastic snaps.

13. The particle retainer of claim 1, wherein the at least one air flow port has a cross-sectional flow path of at least 1.0 square centimeters.

14. The particle retainer of claim 1, wherein the particle retainer weighs less than 5 lbs.

15. A respiration system comprising:
a particulate matter filtration mask;
at least one air filtration element affixed to the particulate matter filtration mask and configured to filter particulate matter from contaminated ambient air entering the particulate matter filtration mask; and
a particle retainer including a support frame, a mask mount, and an air flow port cover,
the support frame including at least one air flow port configured to permit the contaminated ambient air to reach the at least one air filtration element,
the mask mount fixed to the support frame and configured to removably attach to at least one of the particulate matter filtration mask and the at least one air filtration element,
the air flow port cover affixed to the support frame and having an open state and a closed state, the open state permitting the contaminated ambient air to pass through the at least one air flow port, and the closed state prohibiting particulate matter from passing back through the at least one air flow port.

16. The respiration system of claim 15, wherein the particle retainer is removable from the at least one air filtration element.

17. The respiration system of claim 15, wherein the particulate matter filtration mask covers at least half of a user's face.

18. The respiration system of claim 15, further comprising a set of instructions; and
wherein the respiration system is arranged as a kit.

19. A method of use for a respiration system, the method comprising the steps of:
providing a particulate matter filtration mask, the particulate matter filtration mask having at least one air filtration element affixed to the particulate matter filtration mask and configured to filter particulate matter from contaminated ambient air entering the particulate matter filtration mask;
providing a particle retainer for the particulate matter filtration mask, the particle retainer including a support frame, a mask mount, and an air flow port cover, the support frame including at least one air flow port configured to permit the contaminated ambient air to reach the at least one filtration element, the mask mount fixed to the support frame and configured to removably attach to at least one of the particulate matter filtration mask and the at least one filtration element, the air flow port cover affixed to the support frame and having an open state and a closed state, the open state permitting the contaminated ambient air to pass through the at least one air flow port, and the closed state prohibiting particulate matter from passing back through the at least one air flow port;
attaching the particle retainer to the air filtration element;
opening the particle retainer; and
closing the particle retainer.

20. The method of claim 19, further comprising the steps of:
removing the particle retainer from the air filtration element; and
cleaning the particle retainer.
